(19) United States
(12) Patent Application Publication
(10) Pub. No.: US 2025/0276484 A1
(43) Pub. Date: Sep. 4, 2025

(54) THERMAL TREATMENT UNIT FOR PREFORMS

(71) Applicant: SIDEL PARTICIPATIONS, Octeville-sur-Mer (FR)

(72) Inventors: Stéphane MORIN, OCTEVILLE-SUR-MER (FR); Marc MOUCHELET, OCTEVILLE-SUR-MER (FR); Anthony LE PECHOUR, OCTEVILLE-SUR-MER (FR)

(21) Appl. No.: 19/061,302

(22) Filed: Feb. 24, 2025

(30) Foreign Application Priority Data
Feb. 29, 2024 (FR) 2402012

(51) Int. Cl. B29C 49/68; B29C 49/64

(52) U.S. Cl. CPC B29C 49/684; B29C 49/6418; B29C 49/6445

(57) ABSTRACT

Provided is a thermal treatment unit for preforms that includes an element for blocking radiation toward the neck of the preforms. The unit can include a first wall having a first heating element and a second wall having a second heating element, a first grip and move system for gripping and moving preforms on a first row, a second grip and move system for gripping and moving preforms on a second row. The unit also includes a blocking element extending between the first and second rows to block radiation emitted by the first heating element and the second heating element toward the second grip and move system and toward the first grip and move system, respectively.

### CROSS-REFERENCE TO RELATED APPLICATIONS

This application claims the benefit of French Application No. FR2402012, filed Feb. 29, 2024, the entire contents of which are hereby incorporated herein by reference.

### BACKGROUND

In general, during thermal treatment of a preform for container manufacturing, it is necessary to avoid heating the neck of the preform, since the neck already has its definitive shape, i.e. the shape it has in the finished container. It is therefore necessary to not make the neck malleable by heating it together with the body of the preform, which will subsequently be deformed during a blow molding operation.

However, when the preforms circulate on two rows in a chamber of a manufacturing installation, the dispersion of the radiation emitted by the heating elements means that a portion of the radiation emitted by the heating elements of a wall is applied to the necks of the preforms of the row furthest away from this wall and thus causes these necks to be heated.

To limit this undesired heating, it can be provided to ventilate the necks of the preforms travelling through the chamber in order to cool the necks. However, such ventilation does not enable cooling that is sufficiently targeted at the necks of the preforms and that portion of the body that extends immediately underneath the neck also risks being cooled, when it is specifically a critical zone which undergoes significant deformation when the containers are being blow molded and as a result requires particular heating. It is to these and other problems that the present disclosure is drawn.

### SUMMARY

The present disclosure relates to a thermal treatment unit for preforms of a container manufacturing installation. The thermal treatment unit can include a chamber delimited by a first wall and a second wall extending on either side of the chamber in a transverse direction, the first wall having at least one first heating element and the second wall having at least one second heating element. The unit can further include a first grip and move system for gripping and moving a first plurality of preforms on a first row (R1) adjacent to the first wall, where the first grip and move system is designed to interact with a neck of each preform of the first plurality of preforms to move said preforms along a predefined circulation path (T) extending in a longitudinal direction substantially perpendicular to the transverse direction. The unit can also include a second grip and move system for gripping and moving a second plurality of preforms on a second row (R2) adjacent to the second wall, where the second grip and move system is designed to interact with a neck of each preform of the second plurality of preforms so as to move said preforms along the circulation path (T). The thermal treatment unit also includes at least one blocking element extending between the first row (R1) and the second row (R2) so as to block radiation emitted by the first heating element toward the second grip and move system and to block radiation emitted by the second heating element toward the first grip and move system such that the necks of the preforms of the first row (R1) and of the second row (R2) are not heated by the first and second heating elements.

### BRIEF DESCRIPTION OF THE DRAWINGS

FIG. 1 is a schematic depiction (top view) of part of a container-producing installation that includes a thermal treatment unit according to various example embodiments.

FIG. 2 is a schematic depiction (top view) of part of a heating section of the thermal treatment unit in FIG. 1, in which the preforms circulate on two rows, according to various example embodiments.

FIG. 3 is a schematic depiction, in cross section, of the thermal treatment unit in FIG. 2. The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

In general, embodiments of the present disclosure provide for a chamber delimited by a first wall and a second wall extending on either side of the chamber in a transverse direction, the first wall comprising at least one first heating element and the second wall comprising at least one second heating element,
a first grip and move system for gripping and moving a first plurality of preforms on a first row adjacent to the first wall, said first grip and move system being designed to interact with a neck of each preform of the first plurality of preforms so as to move said preforms along a predefined circulation path extending in a longitudinal direction substantially perpendicular to the transverse direction,
a second grip and move system for gripping and moving a second plurality of preforms on a second row adjacent to the second wall, said second grip and move system being designed to interact with a neck of each preform of the second plurality of preforms so as to move said preforms along the circulation path.

Such a thermal treatment unit, or oven, is generally equipped with a plurality of heating elements designed to emit heat toward preforms, which are made of synthetic material and travel through the thermal treatment unit while rotating on themselves, in order to apply a heating profile to these preforms and make it possible to subsequently deform them, for example by stretch blow molding, so as to produce containers from the preforms.

It has, for example, been proposed to provide that the chamber of the thermal treatment unit is delimited by two walls extending along the path taken by the preforms and each comprising heating elements that emit heat into the chamber. Such an arrangement makes it possible to improve the energy distribution in the chamber and to improve the efficiency of a thermal treatment unit. Document EP 2 782 741 describes for example such a thermal treatment unit.

According to one embodiment, this disclosure proposes moving the preforms on two rows between the walls of the chamber, this making it possible to improve the efficiency of the thermal treatment unit and the application of heat to the preforms while at the same time limiting the bulk of the heating unit.

While a preform is being heated, it is advantageous to avoid heating the neck thereof, since the neck already has its definitive shape, i.e. the shape it has in the finished container. It is therefore preferable to not make the neck malleable by heating it together with the body of the preform, which will subsequently be deformed during a blow molding operation.

However, when the preforms circulate on two rows in the chamber, the dispersion of the radiation emitted by the heating elements means that a portion of the radiation emitted by the heating elements of a wall is applied to the necks of the preforms of the row furthest away from this wall and thus causes these necks to be heated.

To limit this undesired heating, it can be provided to ventilate the necks of the preforms travelling through the chamber in order to cool the necks. However, such ventilation does not enable cooling that is sufficiently targeted at the necks of the preforms and that portion of the body that extends immediately underneath the neck also risks being cooled, when it is specifically a critical zone which undergoes significant deformation when the containers are being blow molded and as a result requires particular heating.

One of the aims of the disclosure is to overcome these drawbacks by providing a thermal treatment unit for effectively avoiding undesired heating of the necks of the preforms circulating in the chamber of the thermal treatment unit.

To that end, the disclosure relates to a thermal treatment unit of the aforementioned type, comprising at least one blocking element extending between the first row and the second row so as to block radiation emitted by the first heating element toward the second grip and move system and to block radiation emitted by the second heating element toward the first grip and move system such that the necks of the preforms of the first row and of the second row are not heated by the first and second heating elements.

By positioning a blocking element between a heating element of a wall and the grip and move system for gripping and moving the preforms of the row that is away from this wall, the necks of the preforms of this row are not heated owing to the dispersion of the radiation of the heating element, since the grip and move system for gripping and moving the preforms interacts with these necks to transport the preforms in the chamber. This effectively avoids heating the necks of the preforms without having to limit the heating of that portion of the body of the preforms that extends immediately underneath the neck.

The thermal treatment unit according to the disclosure may also comprise one or more of the following features, taken on their own or in any technically feasible combination:
the blocking element comprises a first face extending facing toward and parallel to the first wall of the chamber and a second face extending facing toward and parallel to the second wall of the chamber, said first and second faces being made from or being coated with a material which absorbs the radiation that is emitted by the first and second heating elements and is incident on said first and second faces;
the blocking element also comprises a reflective face extending between the first face and the second face substantially perpendicularly in relation thereto, said reflective face being designed to reflect the radiation that is emitted by the first and second heating elements and is incident on said reflective face toward a body of the preforms of the first row and of the second row;
the blocking element comprises a body provided with a cooling channel extending in the longitudinal direction, said cooling channel being in fluidic communication with a source of a cooling fluid, said cooling fluid flowing in said cooling channel;
the thermal treatment unit comprises a plurality of first heating elements distributed at least along the longitudinal direction on the first wall and a plurality of second heating elements distributed at least along the longitudinal direction on the second wall, the blocking element extending in the longitudinal direction between all of the plurality of first heating elements and second heating elements;
the thermal treatment unit comprises a plurality of first heating elements distributed at least along a vertical direction, perpendicular to the longitudinal direction and to the transverse direction, on the first wall and a plurality of second heating elements distributed at least along the vertical direction on the second wall, the blocking element extending in the vertical direction above or below the plurality of first heating elements and second heating elements;
the first and second heating elements each comprise a plurality of monochromatic or pseudo-monochromatic electromagnetic radiation sources;
the first and second heating elements emit radiation in the transverse direction with an angle of divergence less than or equal to 15° about the transverse direction;
the first and second grip and move systems are arranged such that the preforms of the first row and of the second row are offset from one another in staggered fashion in the longitudinal direction; and
the first and second walls of the chamber and the blocking element are movable in a vertical direction, perpendicular to the longitudinal and transverse directions, relative to the first and second grip and move systems for gripping and moving the preforms.

Other aspects and advantages of the disclosure will become more clearly apparent on reading the following description, which is given solely by way of nonlimiting example and with reference to the appended drawings, in which:

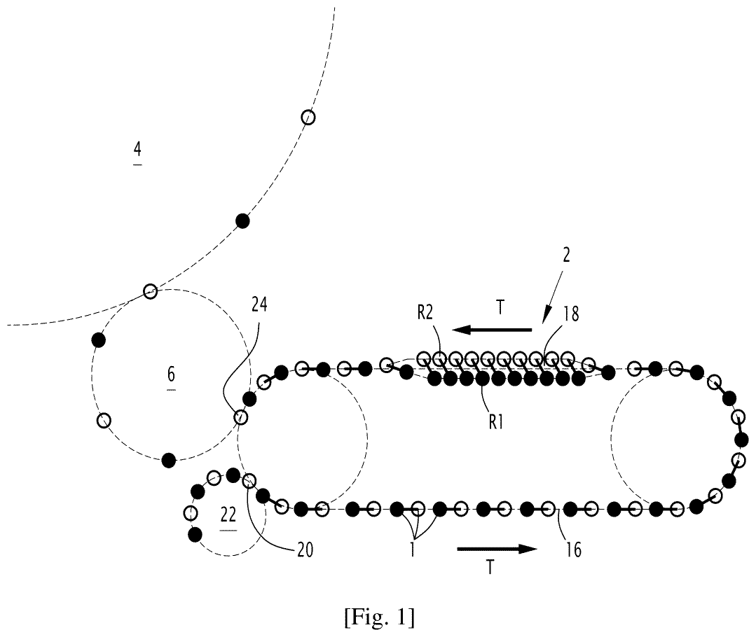

FIG. 1 is a schematic depiction, from above, of part of a container producing installation comprising a thermal treatment unit according to the disclosure,

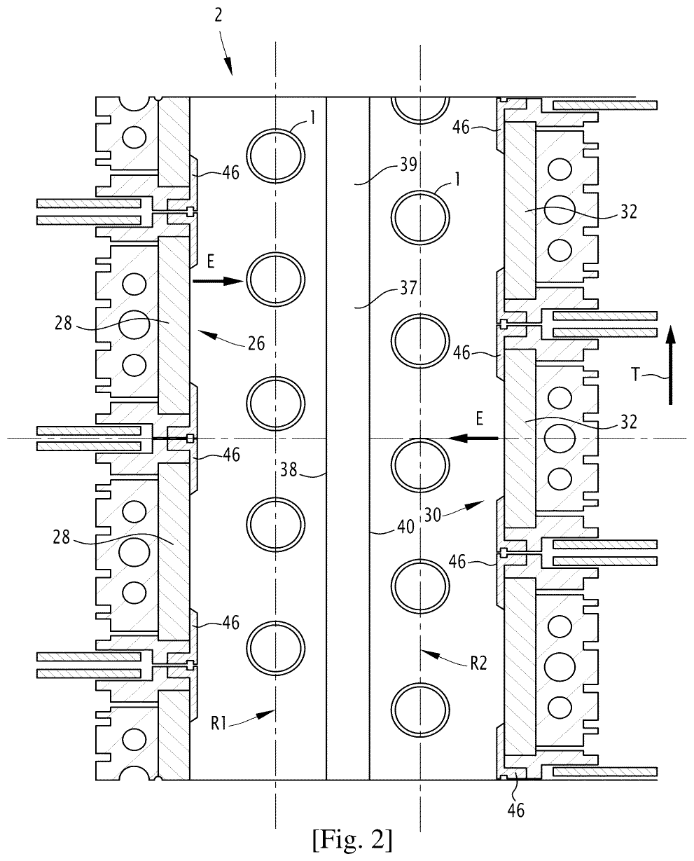

FIG. 2 is a schematic depiction, from above, of part of a heating section of the thermal treatment unit in FIG. 1, in which the preforms circulate on two rows, and

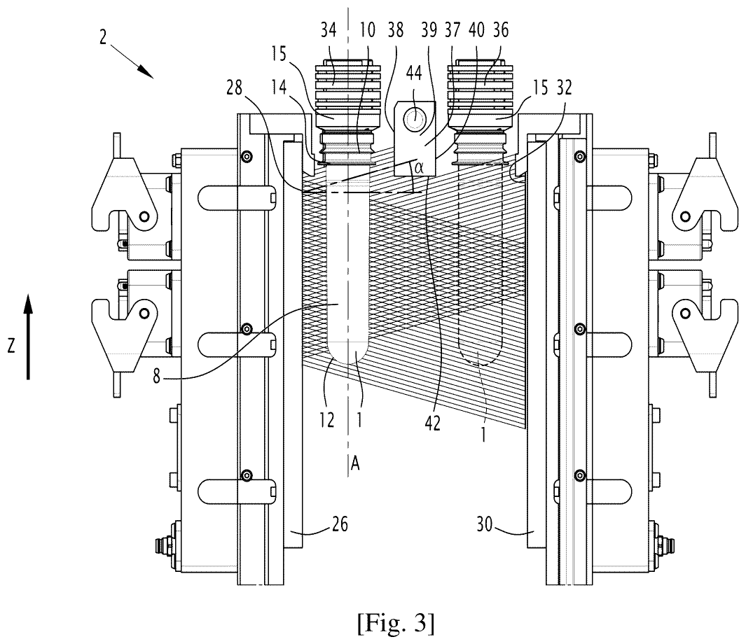

FIG. 3 is a schematic depiction, in cross section, of the thermal treatment unit in FIG. 2.

With reference to FIG. 1, an installation for producing containers from a sequence of preforms 1 will be described.

Such an installation generally comprises at least one thermal treatment unit 2 designed to heat the preforms 1 and a forming station 4 in which the heated preforms 1 are formed to afford containers, for example by stretch blow molding. As shown in FIG. 1, a transfer wheel 6 is for example provided between the thermal treatment unit 2 and the forming station 4 for transferring the heated preforms 1 at the exit of the thermal treatment unit 2 to an entrance of the forming station 4, which is for example formed by a carousel bearing multiple forming units, each designed to form a container from a heated preform 1 while the carousel rotates. Apart from the thermal treatment unit 2, which will now be described in more detail, such a container producing installation is known per se and will not be described in more detail here.

The thermal treatment unit 2, or oven, is designed to heat a sequence of preforms 1 circulating in the thermal treatment unit in order to apply a thermal profile to each preform 1 to make it malleable with a view to subsequently deforming it in the forming station 4.

More particularly, as shown in FIG. 3, each preform 1 comprises a body 8 and a neck 10 and the thermal treatment unit 2 is designed to heat the body 8 without heating the neck 10 of each preform 1, as will be described in more detail below. The body 8 extends along an axis A and has for example the form of a test tube extending between a bottom 12 and the neck 10, which forms an open end of the test tube. The neck 10 comprises for example a flange 14 extending from a radial plane substantially perpendicular to the axis A and projecting out of the body 8. Such a flange 14 forms for example a grip surface of the preform 1 and of the container made from the preform 1. That portion of the preform 1 that extends from the flange 14 to the open end comprises for example a thread for fixing a cap onto the container made from the preform 1. As a result, the neck 10 of the preform 1 has the same shape as the neck of the container made from this preform 1. For this reason, it is preferable to not heat the neck 10 of the preform 1 in the thermal treatment unit 2, in order to avoid any deformation of the neck 10. In addition, keeping the neck 10 cold and rigid makes it possible to provide a non-deformable grip zone of the preform 1 for moving it into the container producing installation, notably into the thermal treatment unit 2 as will now be described.

The thermal treatment unit 2 comprises a grip and move system for gripping and moving a sequence of preforms 1, this system being suitable for grasping the preforms 1 by the neck 10 and moving them into the thermal treatment unit along a predefined circulation path T extending in a longitudinal direction. The grip and move system comprises a plurality of gripping elements 15 disposed one after another along the circulation path T, each gripping element 15 being designed to interact with the neck 10 of a preform 1. According to one embodiment, the gripping elements 15 are also designed to rotate the preforms 1 about their axis A when they are being transported in the thermal treatment unit 2. According to one embodiment, each gripping element 15 comprises a pin on which the neck 10 of a preform 1 is fitted via its open end, the pin being rotatable in order to rotate the preform about its axis A. Such a gripping element 15 is referred to as a “spinner”.

When the preforms 1 are in the thermal treatment unit 2, their axes A extend in a vertical direction Z of the thermal treatment unit 2, as shown in FIG. 3, the vertical direction Z being substantially perpendicular to the longitudinal direction.

According to the embodiment shown in FIG. 1, the thermal treatment unit 2 comprises a transporting section 16, in which the preforms 1 are moved one after another on a single row in the longitudinal direction, and a heating section 18, in which the preforms 1 are moved on two parallel rows R1, R2 extending in the longitudinal direction, as will be described in more detail below. The preforms 1 circulate in the thermal treatment unit 2 from an entry point 20, to which they are brought for example by a transport wheel 22, into the transporting section 16 and then into the heating section 18 as far as an exit point 24, where the heated preforms 1 are collected by the transfer wheel 6 in order to be brought to the forming station 4. According to the embodiment shown in FIG. 1, the grip and move system forms a loop between the transporting section 16 and the heating section 18, i.e. the gripping elements 15, freed of the preforms that they were transporting to the exit point 24, return to the entry point 20 to collect new preforms to be heated.

In the rest of the description, the heating section 18 will be described in more detail with reference to FIGS. 2 and 3, since the rest of the thermal treatment system 2 is known.

At least in the heating section 18, the thermal treatment unit 2 comprises a first wall 26, comprising at least one first heating element 28, and a second wall 30, comprising at least one second heating element 32. The first and second walls 26, 30 are opposite one another on either side of the thermal treatment unit 2 and between them define a chamber within which the preforms 1 circulate along the predefined circulation path T on two rows R1 and R2. The first and second walls 26, 30 are at a spacing from one another in a transverse direction substantially perpendicular to the longitudinal direction and to the vertical direction Z so as to extend on either side of the circulation path T. The height of the first and second walls 26, 30 is defined in the vertical direction Z.

In order to move the preforms 1 on two rows R1 and R2 at a spacing from one another in the transverse direction, in the heating section 18 the grip and move system is separated into a first grip and move system 34, which moves a first plurality of preforms 1 on the first row R1 in the longitudinal direction, and a second grip and move system 36, which moves a second plurality of preforms on the second row R2 in the longitudinal direction. At the entrance of the heating section 18, the grip and move system is for example arranged such that every other preform goes onto the first row R1, and the other preforms go onto the second row R2. At the exit of the heating section 18, the preforms 1 are for example brought together on a single row as far as the exit point 24 of the thermal treatment unit 2, as shown in FIG. 1.

The first row R1 is adjacent to the first wall 26 and the second row R2 is adjacent to the second wall 30. In other words, the preforms 1 moved on the first row R1 are closer, in the transverse direction, to the first wall 26 than the second wall 30 and the preforms moved on the second row R2 are closer, in the transverse direction, to the second wall 30 than the first wall 26. According to one embodiment, the first and second grip and move systems 34, 36 are advantageously arranged such that the preforms 1 are disposed in staggered fashion in the chamber. “In staggered fashion” is understood to mean that the preforms 1 of one row R1 are offset in the longitudinal direction from the preforms 1 of the other row R2. Such a staggered arrangement makes it possible to ensure that the preforms 1 of the first row R1 are also exposed to the radiation emitted by the second heating element 32 between two preforms 1 of the second row R2 and that the preforms 1 of the second row R2 are also exposed to the radiation emitted by the first heating element 28 between two preforms 1 of the first row R1. As a result, the preforms 1 of the two rows R1, R2 are heated evenly. The spacing in the transverse direction between the rows R1, R2 and the spacing in the longitudinal direction between the preforms 1 can be adjusted on the basis notably of the diameter of the preforms 1.

The first heating element 28 and the second heating element 32 are for example assigned to one another to form a pair of heating elements. As will be described in more detail below, the thermal treatment unit 2 comprises for example several pairs of heating elements, each formed by a first heating element 28 extending on the first wall 26 and a second heating element 32 extending on the second wall 30. The first and second heating elements 28, 32 extend at least partially facing one another, one on each side of the chamber. “Extending at least partially facing one another, one on each side of the chamber” is understood to mean that the first and second heating elements 28, 32 extend substantially at a single height in the vertical direction Z and at least partially one facing the other in the transverse direction. According to an embodiment shown in FIG. 2, the first and second heating elements 28, 32 of a pair of heating elements are offset from one another in the longitudinal direction such that the second heating element 32 extends only partially facing the first heating element 28. Such an embodiment is for example described in the document EP 2 782 741 and a person skilled in the art will be able to refer to that document to obtain more details about such an embodiment, notably in terms of dimensioning and positioning of the heating elements relative to one another.

The first heating element 28 and the second heating element 32 of a pair of heating elements are identical. Thus, only the first heating element 28 will now be described in more detail.

The first heating element 28 comprises for example a plurality of monochromatic or pseudo-monochromatic electromagnetic radiation sources. More particularly, the first heating element 28 is for example a laser emitter and the radiation sources are laser chips designed to emit laser radiation in the infrared range in an emission direction E substantially parallel to the transverse direction. The radiation sources are for example arranged next to one another on a support so as to form at least one row of radiation sources extending in the longitudinal direction. According to one embodiment, the radiation sources form at least one upper row and at least one lower row disposed one above the other in the vertical direction. The radiation sources are connected electrically in series to one another between a positive connection terminal and a negative connection terminal.

Such heating elements are for example described in the document FR 3 124 030 and a person skilled in the art will be able to refer to that document to obtain more details, notably as regards the structure of each radiation source, the arrangement of the radiation sources on a support, the interconnection of the radiation sources and the cooling of the heating elements. It will be understood that the disclosure is not limited to heating elements formed by laser emitters and also applies to other types of heating element, such as tubular incandescent lamps of the halogen type.

It should be noted that the radiation emitted by such a heating element is not strictly rectilinear and has a certain divergence. More particularly, the radiation emitted by each radiation source can be instead in the shape of a cone of which the vertex angle α is for example less than or equal to 15°. Such divergent radiation emitted by several radiation sources is shown in FIG. 3 by way of the various oblique lines going from one wall of the chamber to the other. As a result, the radiation emitted by the heating elements facing the upper portions of the bodies 8 of the preforms 1, which are adjacent to the necks 10 of the preforms 1, is liable to strike the necks 10 of the preforms 1 located in the row furthest away from these heating elements, on account of the divergence of the heating elements. For instance, the radiation emitted by a first heating element 28, facing the upper portion of the bodies 8 of the preforms 1 located on the first row R1, is liable to strike the necks 10 of the preforms 1 located on the second row R2, as can be seen in FIG. 3. Similarly, the radiation emitted by a second heating element 32, facing the upper portion of the bodies 8 of the preforms 1 located on the second row R2, is liable to strike the necks 10 of the preforms 1 located on the first row R1. As a result, the necks 10 of the preforms 1 are liable to be heated in the heating section 18, whereas this is not desirable.

In order to avoid this undesired heating, the thermal treatment unit 2 according to the disclosure comprises at least one blocking element 37 for blocking the radiation emitted by the first and second heating elements 28, 32 toward the necks 10 of the preforms 1 located in the chamber. More particularly, the blocking element 37 is disposed between the two rows R1, R2 in the transverse direction facing the first and second grip and move systems 34, 36 for gripping and moving the preforms 1, more particularly facing the pins of the gripping elements 15, i.e. facing the necks 10 fitted on these pins when the preforms 1 are circulating in the heating section 18 so as to protect these necks 10 from the radiation emitted by the first and second heating elements 28, 32.

Thus, according to one aspect, the disclosure also relates to a blocking element 37 for blocking radiation emitted by a heating element, comprising a body 39 having a first face 38 and a second face 40 that are made from or coated with a material which absorbs the radiation that is emitted by the heating element. The first face 38 extends facing and substantially parallel to the first wall 26 and the second face 40 extends facing and substantially parallel to the second wall 30, at an upper or lower end of these first and second walls 26, 30 in the vertical direction Z. Specifically, when the preforms 1 are circulating in the chamber, their necks 10 extend facing one of the ends of the first and second walls 26, 30 in the vertical direction Z. The end facing that from which the necks 10 extend depends on how the preforms 1 are transported. If they are transported “the right way up”, as shown in FIG. 3, the necks 10 of the preforms and the body 39 of the blocking element 37 extend facing the upper end of the first and second walls 26, 30 in the vertical direction Z. If the preforms 1 are transported “upside down”, the necks 10 of the preforms and the body 39 of the blocking element 37 extend facing the lower end of the first and second walls 26, 30 in the vertical direction Z. Thus, the first face 38 extends in the path of the radiation emitted by a first heating element 28 which faces the upper portion of the bodies 8 of the preforms 1, as can be seen by way of the radiation interrupted by the first face 38 in FIG. 3, and the second face 40 extends in the path of the radiation emitted by a second heating element 32 which faces the upper portion of the bodies 8 of the preforms 1. According to one embodiment, the first and second faces 38, 40 are painted black to absorb the radiation emitted by the first and second heating elements 28, 32.

According to one embodiment, the body 39 also comprises a reflective face 42 extending between the first face 38 and the second face 40, substantially perpendicularly in relation thereto, at one end of the body 39 in the vertical direction Z. As shown in FIG. 3, the reflective face 42 is oriented toward the bottom 12 of the preforms 1 circulating in the chamber so as to reflect the radiation that is emitted by the first and second heating elements 28, 32 and is incident on the reflective face 42 toward the bodies 8 of the preforms 1 of the first row R1 and of the second row R2. As a result, a portion of the radiation emitted by the first and second heating elements 28, 32 that is oriented toward the blocking element 37 on account of the divergence of this radiation can be sent back toward the bodies 8 of the preforms 1, and this improves the heating power of these heating elements by reducing the loss of radiation caused by the divergence. Along that end of the first and of the second wall 26, 30 that the blocking element 37 faces, the reflective face 42 forms a lower face (when the blocking element 37 extends facing the upper end of the walls, as shown in FIG. 3) or an upper face (when the blocking element 37 extends facing the lower end of the walls) of the body 39 of the blocking element 37. The reflective nature of the reflective face 42 is for example afforded by polishing the upper or lower face of the body 39 of the blocking element 37 until a mirror polish is obtained.

According to one embodiment, the blocking element 37 also comprises a cooling channel 44 which extends in the body 39 and is in fluidic communication with a source (not shown) of a cooling fluid. The cooling fluid circulates in the cooling channel 44 so as to dissipate the heat absorbed by the first and second faces 38, 40 of the body 39 of the blocking element 37 under the effect of the divergent radiation from the first and second heating elements 28, 32. According to some variants, the cooling fluid is the same as or is different from the cooling fluid used to cool the first and second heating elements 28, 32, as is known. According to one embodiment, the cooling fluid circulating in the cooling channel 44 is glycol water. The cooling channel 44 extends over the length of the body 39 in the longitudinal direction.

As described above, the chamber comprises a plurality of first and second heating elements 28, 32 distributed in the chamber to expose all of the heating section 18, apart from the zone in which the necks 10 of the preforms 1 extend, to the heat emitted by the heating elements. For instance, the first heating elements 28 are distributed at least along the longitudinal direction on the first wall 26 and the second heating elements 32 are distributed at least along the longitudinal direction on the second wall 30, the first and second heating elements 28, 32 of a pair of heating elements extending at least partially facing one another in the transverse direction. As an alternative or in addition, the first heating elements 28 are for example distributed at least along the vertical direction Z on the first wall 26 and the second heating elements 32 are for example distributed at least along the vertical direction Z on the second wall 30, the first and second heating elements 28, 32 of a pair of heating elements extending at least partially facing one another in the transverse direction.

When the first and second heating elements 28, 32 of a pair of heating elements are offset from one another in the longitudinal direction, the first heating element 28 extends at least partially facing a reflective segment 46 of the second wall 30 and the second heating element 32 extends facing a reflective segment 46 of the first wall 26, as shown in FIG. 2. The reflective segments 46 extend for example between adjacent columns of heating elements such that the first and second walls 26, 30 both emit heat and reflect heat. As indicated above, such an arrangement of the thermal treatment unit 2 is already known per se and will not be described in more detail here. A person skilled in the art can refer to the document EP 2 782 741.

In this case, the blocking element 37 extends advantageously in the longitudinal direction between all the pairs of first and second heating elements 28, 32 distributed along the longitudinal direction, i.e. throughout the heating section 18 in the longitudinal direction. As an alternative or in addition, the blocking element 37 extends facing a portion of the upper or lower pair of first and second heating elements 28, 32 or above or below this pair in the vertical direction Z so as to block only that portion of the radiation that is oriented toward the necks 10 of the preforms 1.

According to one embodiment, the assembly formed by the first and second walls 26, 30 and the blocking element 37 can be moved in the vertical direction Z relative to the first and second grip and move systems 34, 36 for gripping and moving the preforms in order to adapt the position of this assembly to the various models of preforms 1 that are likely to circulate in the chamber, notably to the various heights of these preforms 1. According to one embodiment, the first and second walls 26, 30 and the blocking element 37 can be moved together in the vertical direction Z such that modifying the position of one of the elements of this assembly causes the position of the other elements of this assembly to be modified. In a variant, the blocking element 37 can be moved independently of the first and second walls 26, 30, i.e. the position of the blocking element 37 can also be controlled independently of that of the first and second walls 26, 30.

The blocking element 37 described above makes it possible to effectively avoid heating of the necks 10 of the preforms 1 in the heating section 18 without requiring specific ventilation for the necks 10 and without having to reduce the heating power supplied to the upper zone of the bodies 8 of the preforms 1 that is adjacent to the neck 10. This is particularly advantageous because the upper zone of the body 8 of a preform 1 is generally a zone which must undergo considerable deformation when a container is being produced. This is because this zone generally forms a flared portion or a shoulder of the container in which the diameter of the container increases to create a transition between the neck and the rest of the body of the container. It is thus essential for this zone to be effectively heated in order to control such a deformation.

Therefore, at least the following is claimed:

1. A thermal treatment unit for preforms of a container manufacturing installation, the thermal treatment unit comprising:
a chamber delimited by a first wall and a second wall extending on either side of the chamber in a transverse direction, the first wall comprising at least one first heating element and the second wall comprising at least one second heating element,
a first grip and move system for gripping and moving a first plurality of preforms on a first row (R1) adjacent to the first wall, said first grip and move system being designed to interact with a neck of each preform of the first plurality of preforms so as to move said preforms along a predefined circulation path (T) extending in a longitudinal direction substantially perpendicular to the transverse direction,
a second grip and move system for gripping and moving a second plurality of preforms on a second row (R2) adjacent to the second wall, said second grip and move system being designed to interact with a neck of each preform of the second plurality of preforms so as to move said preforms along the circulation path (T),
wherein the thermal treatment unit comprises at least one blocking element extending between the first row (R1) and the second row (R2) so as to block radiation emitted by the first heating element toward the second grip and move system and to block radiation emitted by the second heating element toward the first grip and move system such that the necks of the preforms of the first row (R1) and of the second row (R2) are not heated by the first and second heating elements.

2. The thermal treatment unit as claimed in claim 1, in which the blocking element comprises a first face extending facing toward and parallel to the first wall of the chamber and a second face extending facing toward and parallel to the second wall of the chamber, said first and second faces being made from or being coated with a material which absorbs the radiation that is emitted by the first and second heating elements and is incident on said first and second faces.

3. The thermal treatment unit as claimed in claim 2, in which the blocking element also comprises a reflective face extending between the first face and the second face substantially perpendicularly in relation thereto, said reflective face being designed to reflect the radiation that is emitted by the first and second heating elements and is incident on said reflective face toward a body of the preforms of the first row (R1) and of the second row (R2).

4. The thermal treatment unit as claimed in claim 1, in which the blocking element comprises a body provided with a cooling channel extending in the longitudinal direction, said cooling channel being in fluidic communication with a source of a cooling fluid, said cooling fluid flowing in said cooling channel.

5. The thermal treatment unit as claimed in claim 1, comprising a plurality of first heating elements distributed at least along the longitudinal direction on the first wall and a plurality of second heating elements distributed at least along the longitudinal direction on the second wall, the blocking element extending in the longitudinal direction between all of the plurality of first heating elements and second heating elements.

6. The thermal treatment unit as claimed in claim 1, comprising a plurality of first heating elements distributed at least along a vertical direction (Z), perpendicular to the longitudinal direction and to the transverse direction, on the first wall and a plurality of second heating elements distributed at least along the vertical direction (Z) on the second wall, the blocking element extending in the vertical direction (Z) above or below the plurality of first heating elements and second heating elements.

7. The thermal treatment unit as claimed in claim 1, in which the first and second heating elements each comprise a plurality of monochromatic or pseudo-monochromatic electromagnetic radiation sources.

8. The thermal treatment unit as claimed in claim 1, in which the first and second heating elements emit radiation in the transverse direction with an angle (a) of divergence less than or equal to 15° about the transverse direction.

9. The thermal treatment unit as claimed in claim 1, in which the first and second grip and move systems are arranged such that the preforms of the first row (R1) and of the second row (R2) are offset from one another in staggered fashion in the longitudinal direction.

10. The thermal treatment unit as claimed in claim 1, in which the first and second walls of the chamber and the blocking element are movable in a vertical direction (Z), perpendicular to the longitudinal and transverse directions, relative to the first and second grip and move systems for gripping and moving the preforms.
